(19) United States
(12) Patent Application Publication
(10) Pub. No.: US 2014/0347179 A1
(43) Pub. Date: Nov. 27, 2014

(54) Wireless Warning Light Programming

(71) Applicant: Federal Signal Corporation, Oak Brook, IL (US)

(72) Inventors: Vincent S. Fleszewski, Crown Point, IN (US); Robert J. Hartke, Beecher, IL (US); Jeffery M. Loftus, Tinley Park, IL (US); Paul M. Gergets, St. John, IN (US)

(21) Appl. No.: 13/902,609

(22) Filed: May 24, 2013

(51) Int. Cl. B60Q 1/26; G08C 17/02

(52) U.S. Cl. CPC B60Q 1/26; G08C 17/02
USPC 340/468

(57) ABSTRACT

An example system for wirelessly changing a light flash pattern in a light element of a vehicle includes: a light element attached to a vehicle; a controller circuit located in the light element configured for receiving a light flash pattern signal, wherein the controller circuit includes: an antenna; a microcontroller configured for data communication; a lighting control circuit configured for controlling a light flash pattern of the light element; and an EEPROM used for storing the light flash pattern signal; and a transmitter device capable of transmitting the light pattern signal to the controller circuit.

### BACKGROUND

Emergency response vehicles, construction vehicles, tow and recovery vehicles, and utility vehicles each have flashing warning lights, such as perimeter lights or a light bar positioned on the vehicle, to provide warning signals to pedestrians and drivers. These warning lights flash in various patterns that are controlled by a microcontroller located in the light. Setting the flash patterns is usually done upon installation of the light and involves grounding various wires connected to the lights and/or pressing a button inside the light to advance the flash pattern to another pattern. After installation, changing these settings is a more difficult process and requires unscrewing the light, powering up the light, re-wiring the light or selecting a button located inside the light to advance the flash pattern to a desired pattern, and screwing the light back on. Such a process can be cumbersome, particularly with vehicles having multiple lights.

### SUMMARY

In general terms, this disclosure is directed to wirelessly programming a warning light flash pattern. One aspect of the present disclosure relates to a system for wirelessly changing the light flash pattern in a light element located on a vehicle, the system comprising a light element attached to a vehicle and a controller circuit located in the light element configured for receiving a light flash pattern signal. In this aspect, the controller circuit includes an antenna, a microcontroller configured for data communication, a lighting control circuit configured for controlling a light flash pattern of the light element, and an EEPROM used for storing the light flash pattern signal. The system further includes a transmitter device capable of transmitting the light pattern signal to the controller circuit.

Another aspect of the present disclosure relates to a method for wirelessly changing the light flash pattern in a light element of a vehicle, the method comprising registering a handheld transmitter device to a vehicle and selecting a light flash pattern on the handheld transmitter device using an application operating thereon. The method further includes sending a light flash pattern signal to a controller circuit in a light element located on the vehicle, and changing, using a microcontroller, the light flash pattern of the light element.

### BRIEF DESCRIPTION OF THE DRAWINGS

FIG. 1 is a schematic block diagram of an example warning light pattern reconfiguration system.

FIG. 2 is a schematic block diagram illustrating an example wireless controller system used for changing the flash pattern of a light element in the system of FIG. 1.

FIG. 3 is a schematic block diagram illustrating example processes used by a microcontroller as shown and described in FIG. 2.

FIG. 4 is an example display of an application used by a handheld transmitter as shown in FIG. 1.

FIG. 5 is a flow chart of an example method for selecting and changing a light flash pattern of a light element on an emergency response vehicle.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The present disclosure relates to a wireless system for changing light patterns of light elements on emergency response vehicles, such as perimeter lights and light bars. In the examples described, the wireless system includes a controller assembly placed within or near the light element of the vehicle and a handheld transmitter used to select and thereafter wirelessly program the light element with the desired light flash pattern. Additional details are provided below.

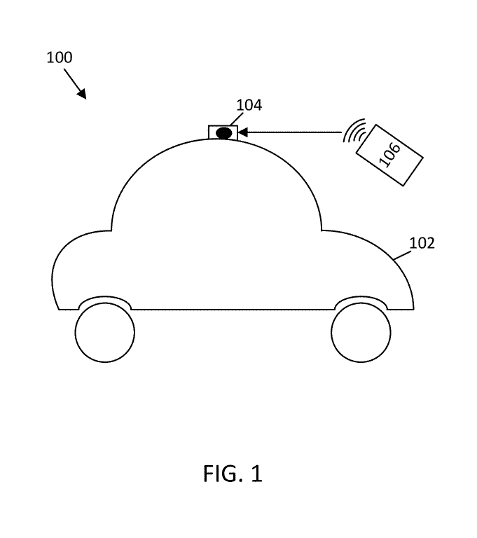

FIG. 1 is a schematic block diagram of an example warning light pattern reconfiguration system 100. The system 100 includes an emergency response vehicle 102 with an attached light element 104, and a handheld transmitter device 106.

In example embodiments, the light element 104 is a warning light, such as a perimeter light or a light in a light bar mounted to the vehicle. Other types of warning lights can be used.

In this example, the light element 104 includes a plurality of lights (e.g., incandescent and/or LED lights) that flash in certain patterns. Examples of such warning lights are described in U.S. Pat. Nos. 5,884,997, 6,966,682, 7,476,013, RE36,245, 8,197,110, 8,206,005, and 8,226,265, the entireties of which are hereby incorporated by reference.

In this embodiment, the handheld transmitter device 106 is used to program a light pattern of the light element 104 on the emergency response vehicle 102. As shown in this embodiment, the handheld transmitter 106 is held near the light element 104 on the vehicle 102 when programming the flash pattern of the light element 104. Examples of handheld transmitters include, but are not limited to, a mobile phone, a personal digital assistant, or a tablet or laptop computer.

Examples of emergency response vehicles 102 include, but are not limited to, law enforcement vehicles, ambulances, fire trucks, security cars, or government vehicles. In other embodiments, the light element is located on non-emergency response vehicles such as construction vehicles, tow and recovery vehicles, utility vehicles, or government vehicles.

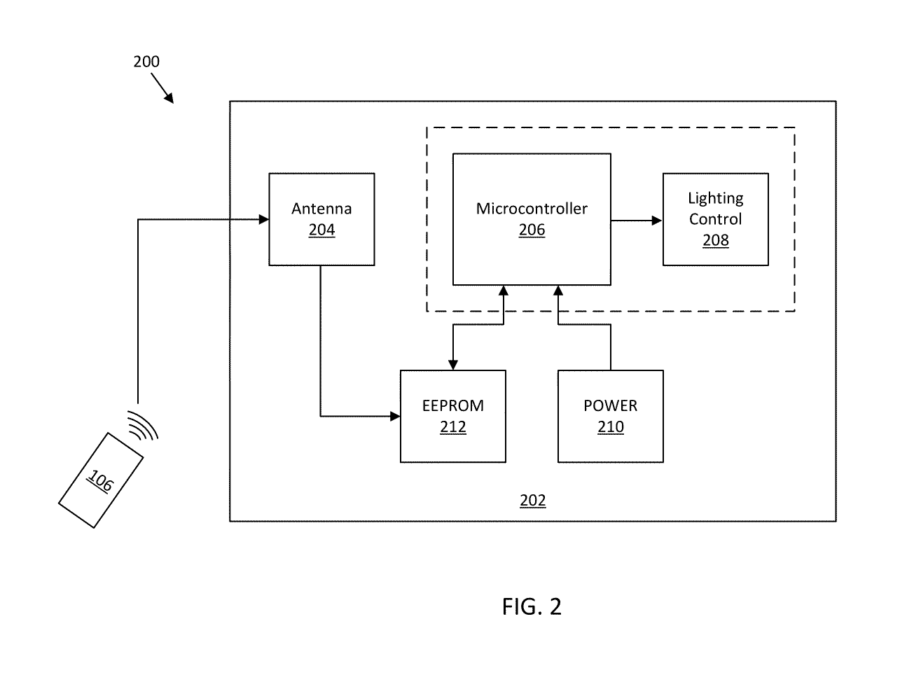

FIG. 2 is a schematic block diagram illustrating an example wireless controller system 200 used for changing the flash pattern of a light element 104 on a vehicle 102. In this example embodiment, the system 200 includes a handheld transmitter 106 and a controller circuit 202. The controller circuit 202 further includes an antenna 204, a microcontroller 206, lighting control 208, a power input 210, and an EEPROM 212. The power interface 210 provides power to each of the active components within the controller circuit. In other embodiments, the RF energy from the antenna 204 provides power to the EEPROM 212.

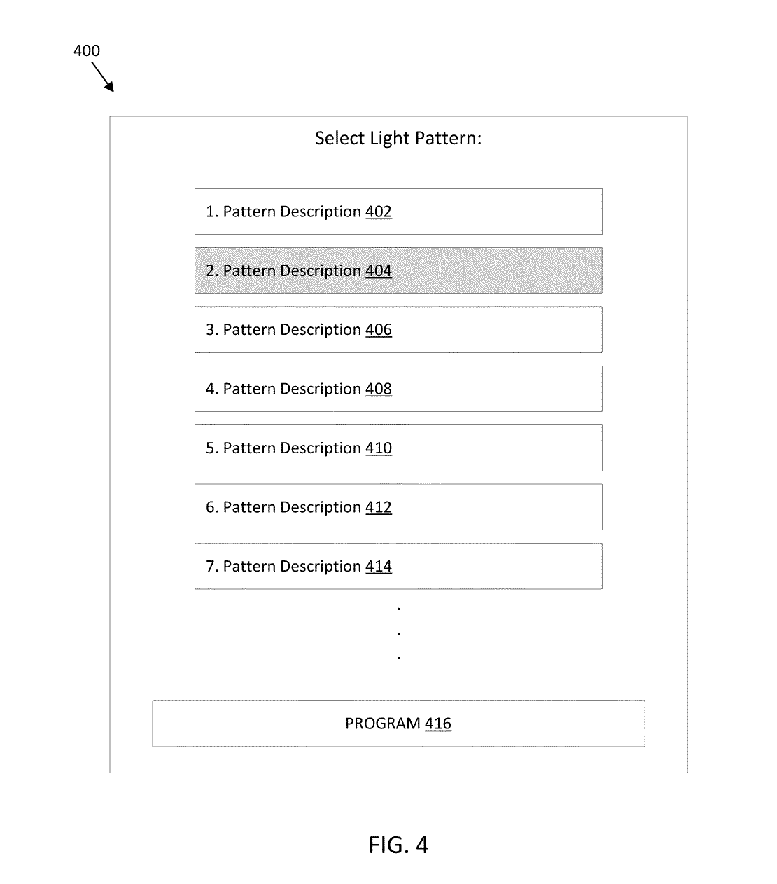

In operation, the wireless controller system 200 for changing the light pattern of a light element on a vehicle requires a user to select a desired light pattern and send a wireless signal to the controller circuit 202 using the handheld transmitter 106. In this embodiment, the handheld wireless transmitter 106 is capable of communicating with the controller circuit 202 using near-field communication (hereinafter “NFC”) operating on an ISO 15693 radio frequency (hereinafter “RF”) interface at 13.56 MHz. NFC allows a device, such as the handheld transmitter 106, to communicate wirelessly with another device, such as the EEPROM 212, that is close in proximity to it. The EEPROM 212 accesses and demodulates data on the 13.56 MHz frequency RF signal that is received by the antenna. In other embodiments, other carrier frequencies are used. In some embodiments, the handheld transmitter 106 must be located within one to two inches from the receiving device. In other embodiments, other ranges are used. In other embodiments, other wireless technologies, such as Bluetooth or ZigBee, can be used. The light pattern selection method is discussed in further detail with reference to FIG. 4.

The antenna 204 in the controller circuit 202 receives a light pattern signal sent by the handheld transmitter 106. In this embodiment, the antenna 204 stores the light pattern signal in an EEPROM 212 that is also located in the controller circuit 202. In this embodiment, the EEPROM 212 can be reprogrammed by a user without having to be powered up. The microcontroller 206, which is also located in the controller circuit 202, retrieves the light pattern stored in the EEPROM 212 over an inter-integrated circuit (hereinafter “I2C”) interface. The microcontroller 206 can be one of a variety of types of microprocessors such as a digital signal processor or any other type of programmable device. The microcontroller 206 thereafter sends the light pattern signal to the lighting control 208. The lighting control 208 is responsible for controlling the light flash pattern in the light element 104 on the vehicle 102.

In one example, the handheld device 106 sends a designator that is used to select a particular pattern pre-stored in the EEPROM 212. In other examples, the handheld device 106 sends a code that is used to program the EEPROM 212 for the particular light pattern that is desired. In some embodiments, the wireless signal sent to the controller circuit 202 is encrypted and thereafter decrypted by the EEPROM 212, the microcontroller 206, or another decryption device. Such an encryption/decryption scheme maintains a level of security, thus enabling only selected devices to change flash patterns on a light element 104 of a vehicle 102.

In these examples, the transmitter device is a computing device that includes one or more processing units and computer readable media. Computer readable media includes physical memory such as volatile memory (such as RAM), non-volatile memory (such as ROM, flash memory, etc.) or some combination thereof. Additionally, the computing device can include mass storage (removable and/or non-removable) such as a magnetic disk or an optical disk or a tape. An operating system, such as Linux or Windows, and one or more application programs can be stored on the mass storage device. The computing device can include input devices (such as a keyboard and mouse) and output devices (such as a monitor and printer).

The computing device also includes connections to other devices, computers, servers, etc., such as through a network. In example embodiments, the computing device communicates with other components through one or more networks, such as a local area network (LAN), a wide area network (WAN), the Internet, or a combination thereof. Communications can be implemented using wired and/or wireless technologies.

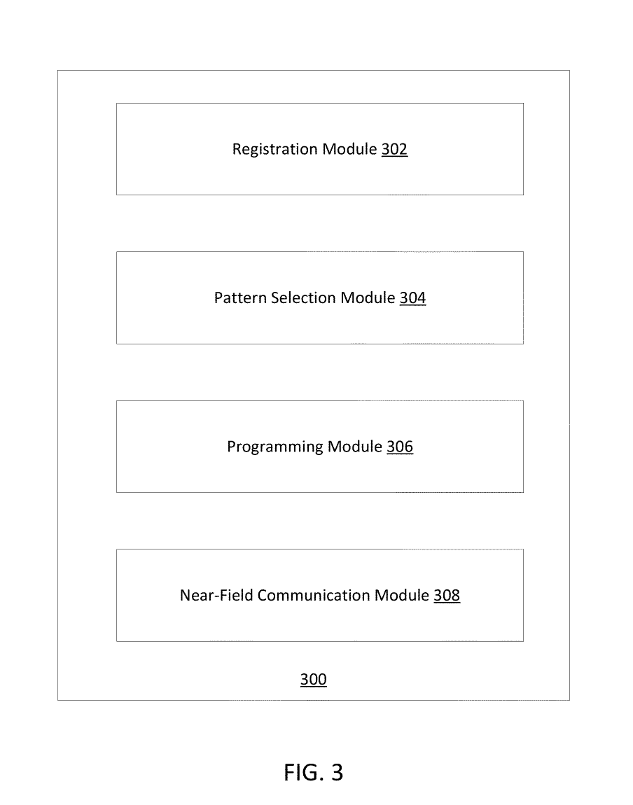

FIG. 3 is a schematic block diagram illustrating an example application module 300 used by a handheld transmitter 106 as shown in FIG. 2. In some embodiments, a user installs the application module 300 on a handheld transmitter 106. The application module 300 is a user interface for selecting a desired light element flash pattern and wirelessly programming that pattern in the light element 104. In this embodiment, the application module 300 includes a registration module 302, a pattern selection module 304, a programming module 306, and a near-field communication module 308.

The registration module 302 is responsible for registering the user's handheld transmitter device 106 with the user's vehicle 102 so that only authorized users can use the handheld transmitter 106 to change a vehicle's light element flash pattern. In some embodiments, the registration module 302 is also responsible for setting up a username and password for the particular user and/or the user's vehicle 102.

The pattern selection module 304 enables the user to select a desired light element flash pattern from a list of pattern options. In some embodiments there are up to 28 different light element flash patterns. Each pattern defines such aspects as the color of the flash patterns, the relative length of the flash patterns, etc. In other embodiments, there are more or fewer preset light patterns.

As noted, the selection can simply be between preset light patterns, and a particular designation for the selected light pattern is sent by the handheld device. In other examples (not shown), the application can be used to define new and/or different light patterns by programming particular aspects such as color, intensity, duration, etc. This new pattern can be sent by the handheld device for programming the light element 104. Other examples are possible.

The programming module 306 enables the user to program the light element 104 with the desired light element flash pattern. The programming module 306 is responsible for sending a light pattern signal including the desired light element flash pattern from the handheld transmitter 106 to the controller circuit 202 located inside the light element 104.

The NFC module 308 manages the near-field communication between the handheld transmitter 106 and the controller circuit 202 in the light element 104. The NFC module 308 is also responsible for managing the communications protocols required for a handheld transmitter 106 to communicate with the controller circuit 202. In some embodiments, the NFC module 308 enables two-way communication between the handheld transmitter 106 and the controller circuit 202.

Referring to FIG. 4, an example application 400 used by a handheld transmitter 106 is shown. This application 400 is an example of the user interface for selecting a desired light pattern 402-414. Such an application can, for example, be a downloadable program that is installed on the handheld transmitter. In other examples, the application can be a web-based program or service that is accessible using a browser on the handheld transmitter. Other configurations are possible.

In this example, the application 400 displays a list of light flash pattern 402-414 options from which the user may select. In this embodiment, the application provides a short description of each light flash pattern 402-414. In other embodiments, the display alternatively provides a graphical illustration of each light flash pattern 402-414. Additionally in some embodiments, the application 400 provides user information including the user's name and vehicle identification number (not shown). In other embodiments, the application 400 also displays information regarding the user's distance from the vehicle 102 and/or whether the user must reduce the distance between the handheld transmitter 106 and the vehicle 102. In this example, the user selected light pattern two 404, which is highlighted to identify the selection. The application 400 provides a ‘program’ button 416 that allows the user to program the light element 104 with selected light flash pattern two 404.

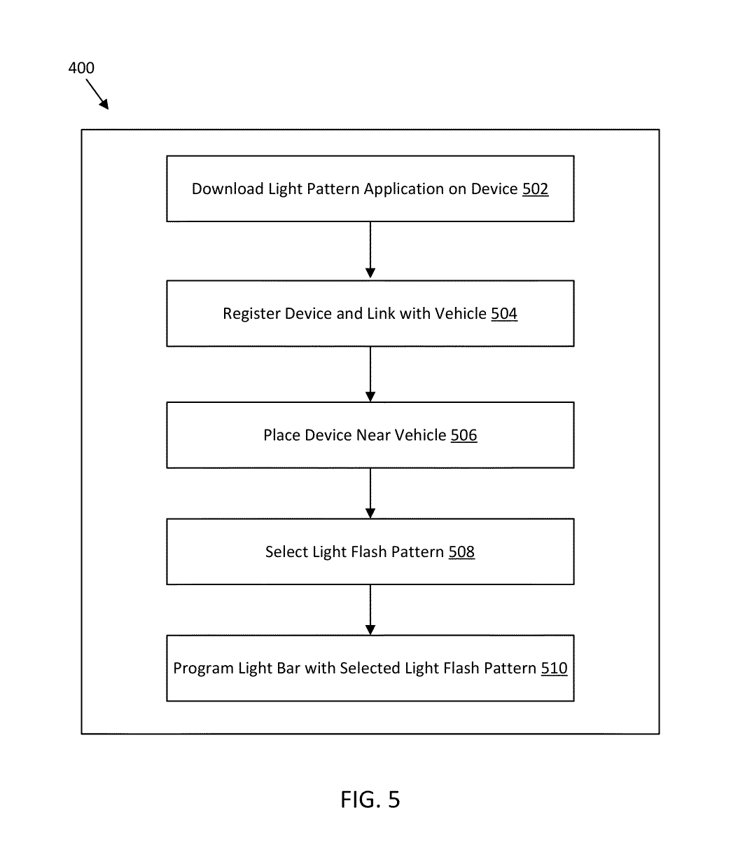

Referring now to FIG. 5, a flow chart of an example method 500 for selecting and changing a light flash pattern of a light element 104 on an emergency response vehicle 102 is shown. In this example, the method 500 includes downloading the light pattern application on a handheld transmitter device 106 (Step 502), registering the device 106 and linking it to a vehicle 102 (Step 504), placing the device 106 near the vehicle 102 (Step 506), selecting a light flash pattern (Step 508), and programming the light element 104 with the selected light flash pattern (Step 510).

In this example method 500, the first step to selecting and changing a light flash pattern is to download the light pattern application on a handheld transmitter device 106 (Step 502). This initial download is only performed once and is thereafter saved to the handheld transmitter 106. In some embodiments, the user can download the application on a second handheld transmitter device 106.

For example, the user can access an application store, select the desired application, and download/install the application on the handheld transmitter device 106 (if such application is not already installed). In other examples, the application is accessible over the web using a browser on the handheld transmitter device.

In this example, registering the device and linking it with a vehicle (Step 504) involves creating a user identification and an associated password and linking the user identification with a particular vehicle 102. In some embodiments, linking the user identification with a particular vehicle 102 involves adding a vehicle identification code in the registration process. This feature prevents a user from programming the light pattern of another user's vehicle 102.

For example, in one embodiment, a central database is maintained for the users who are authorized to program a particular vehicle. When the user accesses the application, the application obtains the user's credentials (e.g., user name and password) and checks the credentials against the database. If the user is authorized, the application allows the user to proceed with the programming. If not, an error is returned, and no programming is allowed.

In this embodiment, the next step in the method 500 involves placing the handheld transmitter device 106 near the vehicle (Step 506). In some embodiments, the handheld transmitter device 106 can only transmit the light pattern signal to the controller circuit 202 if it is located within a few inches from the light element 104. In other embodiments, the handheld transmitter 106 can be held at a distance further than a few inches.

In this embodiment, the next step is to select a light flash pattern (Step 508) from a list of light flash patterns, as shown and described in FIG. 4. In this example embodiment, selecting a light flash pattern (Step 508) involves browsing through a variety of light flash pattern options listed in the application (FIG. 5) and selecting a desired light flash pattern.

The final step in the method 500 involves programming the light element 104 (Step 510). Programming the light element 104 (Step 510) involves selecting the program button 416 (FIG. 4), which alerts the handheld transmitter 106 to send the selected light flash pattern signal to the controller circuit 202. As described in FIG. 2, an antenna 204 within the controller circuit 202 receives the light pattern signal and stores the signal in the EEPROM 212. A microcontroller 206 retrieves the light flash pattern signal and sends it to a lighting control circuit 208 responsible for controlling the light element flash pattern.

In some embodiments, the steps of the method 500 are performed in a different order. For example, in an alternative embodiment, the user selects a light pattern (Step 508) before placing the handheld transmitter device 106 near the vehicle 102 (Step 506). Yet in other embodiments, the user places the device 106 near the vehicle 102 (Step 506) before downloading the light pattern application on the handheld device 106 (Step 502).

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A system for wirelessly changing a light flash pattern in a light element of a vehicle, the system comprising:
a light element attached to a vehicle;
a controller circuit located in the light element configured for receiving a light flash pattern signal, wherein the controller circuit includes:
an antenna;
a microcontroller configured for data communication;
a lighting control circuit configured for controlling a light flash pattern of the light element; and
an EEPROM used for storing the light flash pattern signal; and
a transmitter device capable of transmitting the light pattern signal to the controller circuit.

2. The system of claim 1, wherein the transmitter device is a mobile phone or a tablet computer.

3. The system of claim 1, wherein the light element is a light bar.

4. The system of claim 1, wherein the microcontroller communicates with the EEPROM using an I2C communication bus.

5. The system of claim 1, further including a downloadable application embedded on the transmitter device, configured for selecting the light flash pattern and sending a signal including the light flash pattern to the controller circuit.

6. The system of claim 1, wherein the controller circuit receives the signal using near-field communication.

7. The system of claim 1, wherein the vehicle is selected from a group consisting of a police car, an ambulance, a fire truck, a utility vehicle, a security car, a construction vehicle, and a tow and recovery vehicle.

8. A method for wirelessly changing a light flash pattern in a light element of a vehicle, the method comprising:
registering a handheld transmitter device to a vehicle;
selecting a light flash pattern on the handheld transmitter device using an application operating thereon;
sending a light flash pattern signal to a controller circuit in a light element located on the vehicle; and
programming, using a microcontroller, the light flash pattern of the light element.

9. The method of claim 8, wherein sending a light flash pattern signal to a controller circuit further includes sending a light pattern signal to a controller circuit using near-field communication.

10. The method of claim 9, further including storing the light flash pattern in an EEPROM located in the controller circuit.

11. The method of claim 10, wherein the EEPROM is capable of receiving data over an ISO 15693 RF interface.

12. The method of claim 8, further including downloading the application on the handheld transmitter device.

13. A method for wirelessly changing a light flash pattern using a handheld device, the method comprising:
placing a handheld device near a vehicle with a light element;
selecting a light flash pattern using the handheld device; and
programming the light element with the light flash pattern by sending a signal including the light pattern to a controller circuit located in the light element.

14. The method of claim 13, wherein selecting a light flash pattern further includes logging into an application downloaded on the handheld device to select the light pattern.

15. The method of claim 13, wherein selecting a light flash pattern further includes logging into a web-based program or service that is accessible using a browser on the handheld device to select the light pattern.

16. The method of claim 13, further comprising:
installing an application on the handheld device;
registering the handheld device using the application;
linking the handheld device to a vehicle.

17. The method of claim 16 wherein registering the handheld device further comprises creating a user identification and a password.

18. The method of claim 13, wherein sending a signal including the light flash pattern to a controller circuit further comprises using near field communication to communicate wirelessly to an EEPROM located in the controller circuit.

19. The method of claim 13, wherein programming the light element with the light flash pattern further includes programming a color of the light element, an intensity of the color, or a duration of the light flash pattern.

20. The method of claim 13, further including programming the light flash pattern of a second vehicle using the handheld device.
